(19) United States
(12) Patent Application Publication
(10) Pub. No.: US 2014/0302701 A1
(43) Pub. Date: Oct. 9, 2014

(54) CORD CONNECTOR

(71) Applicant: Joseph Brillant, Apple Valley, CA (US)

(72) Inventor: Joseph Brillant, Apple Valley, CA (US)

(21) Appl. No.: 14/238,827

(22) PCT Filed: Aug. 14, 2012
(86) PCT No.: PCT/US2012/050806

§ 371 Date: Jun. 11, 2014

Related U.S. Application Data
(60) Provisional application No. 61/523,654, filed on Aug. 15, 2011.

(51) Int. Cl. H01R 13/639; H01R 43/26

(52) U.S. Cl. CPC H01R 13/6392; H01R 43/26
USPC 439/369; 29/876

(57) ABSTRACT

A cord connector can be used in connection with first and second cord units to secure the first and second cord units in a connected and/or mated position. The cord connector can include a first end including a first loop and a second end including a second loop. The first loop can be sized and shaped to receive a portion of a first cord unit. The second loop can be sized and shaped to receive a portion of the second cord unit. The first loop and the second loop can extent approximately perpendicular to the direction of the elongate member. Each of the first and second loops can define a receiving area to hold the portions of the first and/or second cord unit and an access opening to allow portions of the first and/or second cord unit to be placed within the receiving area.

### CROSS-REFERENCE TO RELATED APPLICATIONS

This application claims the benefit of U.S. Provisional Patent Application No. 61/523,654, filed Aug. 15, 2011, entitled Extension Cord Connector, the disclosure of which is incorporated herein by reference in its entirety.

### BACKGROUND OF THE INVENTION

1. Field of the Invention

The specification refers to cord connectors, including, extension cord connectors.

2. Description of the Related Art

The positioning of electrical devices far from an outlet frequently requires the use of a combination of cords such as, for example, an extension cord. While extension cords greatly facilitate the range in which an electrical appliance and/or power tool can be used, use of an extension cord is not always easy. For example, in the event that an electrical appliance needs to be moved to a variety of positions during use, an extension cord can frequently unplug from either the outlet, from another extension cord, and/or from the electric appliance. This unplugging can result in the unexpected loss of power to the electrical appliance. This loss of power to the electrical appliance can be inconvenient, and can in some circumstances be dangerous.

The smallest tug or stretch on electrical cords that are connected to each other can cause those plugs to dislodge. Valuable time could be wasted if a user has to constantly stop what he or she is doing in order to fix a loose connection or retrieve a cord that has fallen into an inaccessible place. Current methods for preventing cords from disconnecting may not be readily available.

Several techniques and devices have been developed to deal with the difficulties that can arise when cords come unplugged unexpectedly. One such method of dealing with this risk is to tie cords together at the point at which they connect to each other. While tying cords together can be effective, this process can be cumbersome, takes time to complete, and decreases the reach of the cords that can be used as some of the length of the cord is lost to the knot. Another alternative to prevent cords from coming unplugged has been the integration of locking features into the plug portions of the cords. While such locking features widespread acceptance and use. Another solution to the problem of cords unplugging is the use of a feature that can be affixed to the cords to prevent them from unplugging. Similar to integrated locking devices in the plug portions of cords, such devices have proven to be costly and impractical to use, and thus have not been widely accepted by the public.

In light of these shortcomings, new devices and techniques are required to connect cords to prevent the unexpected interruption of power to an electrical appliance.

### SUMMARY OF THE INVENTION

Some embodiments relate to a cord connector including an elongate member having a first end and a second end, a first loop located at the first end of the elongate member and extending in a first direction perpendicular to the elongate member, and a second loop located at the second end of the elongate member and extending in the first direction perpendicular to the elongate member, which first and second loops are adapted to prevent uncoupling between a first cord passing through said first loop and a second cord passing through said second loop. In some aspects of all of the embodiments discussed in this paragraph, the first loop defines a first receiving area and a first access opening. In some aspects of all of the embodiments discussed in this paragraph, the first loop defines a first central axis located in the middle of first receiving area and perpendicular to the first receiving area. In some aspects of all of the embodiments discussed in this paragraph, the first central axis is parallel to the elongate member. In some aspects of all of the embodiments discussed in this paragraph, the first central axis is non-parallel to the elongate member. In some aspects of all of the embodiments discussed in this paragraph, the second loop defines a second receiving area and a second access opening. In some aspects of all of the embodiments discussed in this paragraph, the first loop defines a second central axis located in the middle of second receiving area and perpendicular to the second receiving area. In some aspects of all of the embodiments discussed in this paragraph, the second central axis is parallel to the elongate member. In some aspects of all of the embodiments discussed in this paragraph, the second central axis is non-parallel to the elongate member. In some aspects of all of the embodiments discussed in this paragraph, the second central axis is parallel to the second central axis.

Some embodiments relate to a cord system including a first cord unit having a first plug, and a first cord, a second cord unit having a second plug, and a second cord, a first loop located at a first position and partially defining a perimeter of a first receiving area, which first loop defines a first central axis extending through the center of the first loop and partially defining a perimeter of a second receiving area, which second loop defines a second central axis extending through the center of the second loop and perpendicular to the second receiving area, and the first and second loops are adapted to prevent uncoupling between the first cord unit partially passing through said first loop and the second cord unit partially passing through said second loop. In some aspects of all of the embodiments discussed in this paragraph, the cord system further includes an elongate member connecting the first and second loops. In some aspects of all of the embodiments discussed in this paragraph, the first loop is located at a first end of the elongate member and the second loop is located at a second end of the elongate member. In some aspects of all of the embodiments discussed in this paragraph, the cord connector is wire. In some aspects of all of the embodiments discussed in this paragraph, the wire is a metal wire. In some aspects of all of the embodiments discussed in this paragraph, the wire is a plastic wire. In some aspects of all of the embodiments discussed in this paragraph, the cord connector is metal. In some aspects of all of the embodiments discussed in this paragraph, the cord connector is plastic. In some aspects of all of the embodiments discussed in this paragraph, the cord system includes a first access opening partially defining the perimeter of the first receiving area and that can allow an object to be moved, perpendicular to the first central axis, into the first receiving area. In some aspects of all of the embodiments discussed in this paragraph, the cord system includes a second access opening partially defining the perimeter of the second receiving area and that can allow an object to be moved, perpendicular to the second central axis, into the second receiving area. In some aspects of all of the embodiments discussed in this paragraph, the first and second central axes are parallel.

Some embodiments relate to a method of using a cord connector to maintain a connection between a first cord unit and a second cord unit and includes connecting a first plug of a first cord unit to a second plug of a second cord unit, placing a portion of a first cord of the first cord unit in a first receiving area of a first loop of a cord connector, which the first loop is smaller than the first plug, and placing a portion of the second cord unit into a second receiving area of a second loop of the cord connector, which the second loop is smaller than the second plug. In some aspects of all of the embodiments discussed in this paragraph, the portion of the first cord of the first cord unit is placed in the first receiving area of the first loop of the cord connector by passing the first cord through a first access opening. In some aspects of all of the embodiments discussed in this paragraph, the portion of the second cord of the second cord unit is placed in the second receiving area of the second loop of the cord connector by passing the second cord through a second access opening. In some aspects of all of the embodiments the first plug and the second plug when the first cord is positioned in the first receiving area and the second cord is positioned in the second receiving area. In some aspects of all of the embodiments discussed in this paragraph, the method further includes selecting a cord connector having approximately the same length as the length of the connected first plug and second plug.

Some embodiments relate to a method of maintaining a connection between a first cord unit and a second cord unit including obtaining a cord connector having an elongate member having a first end and a second end, a first loop located at the first end of the elongate member and extending in a first direction perpendicular to the elongate member, and a second loop located at the second end of the elongate member and extending in the first direction perpendicular to the elongate member, which first and second loops are adapted to prevent uncoupling between a first cord passing through said first loop and a second cord passing through said second loop, connecting a first plug on said first cord unit to a second plug on said second cord unity, passing said first cord through said first loop, and passing said second cord through said second loop, which first loop is positioned adjacent to said first plug and said second loop is positioned adjacent to said second plug such that uncoupling between said first plug and said second plug is reduced or prevented.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. connector.

FIG. 2 depicts a side view of one embodiment of a cord connector connecting a first cord and a second cord.

### DETAILED DESCRIPTION OF THE PREFERRED EMBODIMENT

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

The following patents, patent applications and other related art may be relevant to cord connectors: U.S. Pat. No. 3,030,601, titled “Electric Cord Connector”, issued Apr. 17, 1962; U.S. Pat. No. 3,999,828, titled “Cord connector and strain reliever”, issued Dec. 28, 1976; U.S. Pat. No. 4,773,874, titled “Power cord clip”, issued Sep. 27, 1988; U.S. Pat. No. 6,907,984, titled “Temporary securing device for electric cords”, issued Mar. 13, 1990; U.S. Pat. No. 4,690,476, titled “Electrical connector securing system”, issued Sep. 1, 1987; U.S. Design Pat. No. Des. 401,559, titled “Retainer for coupled electrical cords”, issued Nov. 24, 1998; U.S. Pat. No. 4,206,961, titled “Extension cord clip”, issued Jun. 10, 1980; U.S. Pat. No. 5,549,482, titled “Apparatus for securing together an attachment plug with an electric receptacle”, issued Aug. 27, 1996; U.S. Pat. No. 4,504,106, titled “Electrical cord securing apparatus”, issued Mar. 12, 1985; U.S. Pat. No. 5,692,270, titled “Chain length adaptor tool”, issued Dec. 2, 1997; and “Black Magic Filters”, retrieved from http://shop.blackmagicfilters.com/SALE-SALe-SAle-24-Pk-Kord-N-Klamp-Extension-Cord-Connector-712458.htm, on Jun. 7, 2012.

An extension cord Connector is a device that can hold two plugs together and keep power flowing through extension cords and electrical devices even when the cord is being stretched and pulled. This unique product is ideal for use at home or in a workshop and can be stored easily. Workers in the electrical industry, do it yourselfers and many other consumers will appreciate the durability and practicality that this product affords. extension cords so that they will not become disconnected. The invention can be comprised of heavy wire, plastic or other suitable material and can measure approximately 3″ long. The wire or plastic can curl into a loop on each end and then wrap around the cords to secure them in place. The exact specifications may vary.

Embodiments described herein relate generally to cord connectors, to cords, and to power transmission. For example, some embodiments relate generally to devices configured for securing a plurality of in a connected position. Advantageously, the devices described herein are easy to use and to manufacture.

A cord connector can be configured to connect two cords together to thereby prevent the cords from disconnecting from each other. In some embodiments, for example, portions of the cord connector can be configured to interact with portions of a plurality of cord units to hold the cord units together. In one particular embodiment, for example, portions of a cord connector are configured to interact with portions of a first cord unit and portions of the cord connector are configured to interact with portions of the second cord unit to thereby hold the first cord unit and the second cord unit in a connected position.

In some embodiments, for example, the cord connector can include an elongate member having a first end and a second end. In some embodiments, a first loop portion can be located at the first end of the elongate member and a second loop portion can be located at the second end of the elongate member. The first loop portion and the second loop portion can be configured for attachment to the first cord unit and to the second cord unit to thereby attach the cord connector to the cord units. In some embodiments, the first loop and the second loop can include features configured to allow the first loop and the second loop to easily engage the first cord unit and the second cord unit so that the cord connector can be easily attached to the first and second cord units and can be easily removed from the cord units.

Some embodiments relate to methods of using a cord connector. In one method of using a cord connector, a first cord unit is connected to a second cord unit. In this embodiment, a cord connector can be connected to the first cord unit and to the second cord unit to thereby hold the first and second cord units in a connected position. The connection of the cord connector to the first cord unit and the second cord unit can be achieved via a first loop located at a first end of the cord connector and a second loop located at a second end of the cord connector. A person of skill in the art will recognize that a variety of techniques can be used in connection with a cord connector to connect a first cord unit and a second cord unit. connector 100 can be configured to connect a first cord unit with a second cord unit and to maintain the first cord unit and the second cord unit in a connected position. A cord connector 100 can comprise a variety of shapes and sizes and can be made from a variety of materials. In some embodiments, for example, the cord connector 100 can be made of metal, plastic, natural material, synthetic material, composite, polymer, glass, wood, and/or any other desired material. In some embodiments, the material from which the cord connector 100 is made is limited only by the desired function of the cord connector 100.

In some embodiments, the cord connector 100 can comprise of a variety of dimensions, including any dimension compatible with maintaining cords in a connected position.

As seen in FIG. 1, the cord connector 100 can comprise an elongate member 102. In some embodiments, the elongate member 102 can be configured to be connected with other components of the cord connector 100. In some embodiments, the elongate member 102 can define a length of the cord connector 100. The elongate member 102 can comprise a variety of shapes and sizes and can be made from a variety of materials. In one embodiment, for example, the elongate member 102 can be made from a metal wire such as, for example, a steel wire, or the elongate member can be made from a plastic strip, and/or made from any other desired material.

As further seen in FIG. 1, the elongate member 102 can comprise a first end 104 and a second end 106. In some embodiments, and as shown in FIG. 1, the first end 104 of the elongate member 102 can comprise a first loop 108. The first loop 108 can be configured to receive and/or interact with a portion of one of the cord units. As mentioned, the first loop 108 can be located at the first end 104 of the elongate member 102. In some embodiments, for example, the first loop 108 can be affixed to the first end 104 of the elongate member 102, and in some embodiments, and as shown in FIG. 1, the first loop 108 can comprise an integral component of the elongate member 102. Specifically, as shown in FIG. 1, the first loop 108 can be formed from the same piece of material as the elongate member 102.

The first loop 108 can comprise a variety of shapes and sizes and can be made from a variety of materials. In some embodiments, for example, the first loop 108 can be circular, rectangular, triangular, hexagonal, pentagonal, octagonal, or have any other desired shape. In some embodiments, the first loop 108 can have any diameter compatible with receiving and holding a portion of a cord. curved and can define all or portions of the perimeter of a first receiving area 110. Alternatively, the loop may be made of straight elements which define a first receiving area. The first receiving area 110 defined by the first loop 108 can be sized and shaped to receive and contain a portion of a cord unit.

As further seen in FIG. 1, in some embodiments, for example, the first loop 108 can define a first access opening 112. The first access opening 112 can comprise a portion of the perimeter of the first receiving area 110 which is not bounded by the first loop 108. The first access opening 112 can be configured to allow portions of a cord unit to be moved into and out of the first receiving area 110. The first access opening 112 can comprise a variety of shapes and sizes and can, for example, be dimensioned to allow the movement of a portion of the cord unit into and out of the first receiving area 110. While some embodiments of the first loop 108 may include the first access opening 112, in some embodiments, the first loop 108 may not include the first access opening 112, such as when, the cord connector 100 is permanently attached to a cord.

As also seen in FIG. 1, the first loop 108 defines a first central axis 114. The first central axis 114 can be centered in the first loop 108, and can extend perpendicular to the first receiving area 110. In some embodiments, in which the first loop 108 extends perpendicular to the direction of the elongate member 102, the first central axis 114 can, in some embodiments, be parallel to the elongate member 102. In other embodiments, for example, the first central axis 114 can be non-parallel to the elongate member 102.

In some embodiments, and as shown in FIG. 1, the second end 106 of the elongate member 102 can comprise a second loop 116. The second loop 116 can be configured to receive and/or interact with a portion of one of the cord units. In some embodiments, for example, the second loop 116 can be affixed to the second end 106 of the elongate member 102, and in some embodiments, and as shown in FIG. 1, the second loop 116 can comprise an integral component of the elongate member 102. Specifically, as shown in FIG. 1, in some embodiments the second loop 116 can be formed from the same piece of material as the elongate member 102.

The second loop 116 can comprise a variety of shapes and sizes and can be made from a variety of materials. In some embodiments, for example, the second loop 116 can be circular, rectangular, triangular, hexagonal, pentagonal, octagonal, or have any other desired shape. In some embodiments, the second loop 116 can have any diameter compatible with receiving and holding a portion of a cord. circular and can define all or portions of the perimeter of a second receiving area 118. Alternatively, the loop may be made of straight elements which define a first receiving area. The second receiving area 118 defined by the second loop 116 can be sized and shaped to receive and contain a portion of a cord unit.

As further seen in FIG. 1, in some embodiments, for example, the second loop 116 can define a second access opening 120. The second access opening 120 can comprise a portion of the perimeter of the second receiving area 118 which is not bounded by the second loop 116. The second access opening 120 can be configured to allow portions of a cord unit to be moved into and out of the second receiving area 118. The second access opening 120 can comprise a variety of shapes and sizes and can, for example, be dimensioned to allow the movement of a portion of the cord unit into and out of the second receiving area 118. While some embodiments of the second loop 116 may include the second access opening 120, in some embodiments, the second loop 112 may not include the second access opening 120, such as when, the cord connector 100 is permanently attached to a cord.

As also seen in FIG. 1, the second loop 116 defines a second central axis 122. The second central axis 122 can be centered in the second loop 116, and can extend perpendicular to the second receiving area 118. In some embodiments, in which the second loop 116 extends perpendicular to the direction of the elongate member 102, the second central axis 122 can, in some embodiments, be parallel to the elongate member 102. In other embodiments, for example, the second central axis 122 can be non-parallel to the elongate member 102.

In some embodiments, the second central axis 122 can be parallel with the first central axis 113, and in some embodiments, the second central axis 122 can be non-parallel with the first central axis 113. In some embodiments, both the first and second central axes 114, 122 can be located the same distance and the same direction from the elongate member 102. In some embodiments, the first and second central axes 114, 122 can be located a different distance and/or different direction from the elongate member.

In some embodiments, the first loop 108 and the second loop 116 can have the same orientation, and in some embodiments, the first loop 108 and the second loop 116 can have different orientations. Specifically, in some embodiments, the first access opening 112 of the first loop 108 can have the same orientation as the second access opening 112 of the second loop 108, and in some embodiments, the first access opening 112 of the first loop 108 can have a different orientation than the second access opening 112 of the second loop. additional features to those listed above, and can be made in different configurations than those specifically outlined above.

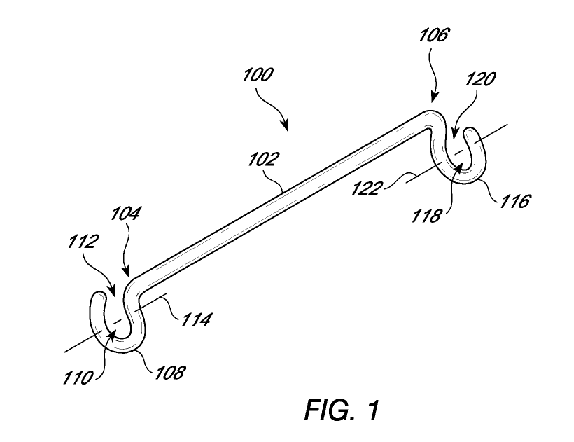

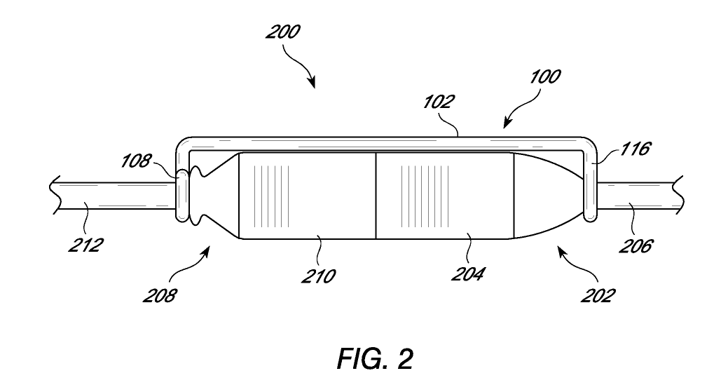

The cord connector 100 can be used to connect one or more cord units. Such use of the cord connector 100 is depicted in FIG. 2. Specifically, FIG. 2 depicts one embodiment of a cord system 200. The cord system 200 comprises a first cord unit 202 having a first plug 204 and a first cord 206, and a second cord unit 208 having a second plug 210 and a second cord 212. In some embodiments, for example, the first cord unit 202 and the second cord unit 208 can be configured to transmit power from a power source such as, for example, an outlet, a battery, a power grid, a power generation system, and/or any other power source to a power-consuming appliance, such as, for example, a power tool, a stove, an oven, a refrigerator, a fan, a blow dryer, and/or any other device that consumes power and/or electricity.

The first and second cord units 202, 208 can comprise a variety of shapes and sizes and can be made from a variety of materials. Further, the first and second cord units 202, 208 can include features to facilitate the transmission of power and/or electricity and the coupling of the first and second cord units 202, 208. Specifically, the first cord unit 202 includes a first plug 204. The first plug 204 can include features configured to allow connection of the first plug 204 with another plug such as, for example, the second plug 210 of the second cord unit 208. In some embodiments, the first plug 204 and/or the second plug 210 can include mating features such as, for example, male mating features and/or female mating features configured to allow the first plug 204 to mate with and connect to the second plug 210. As further seen in FIG. 1, in some embodiments, the first cord unit 202 can comprise a first cord 206. As seen in FIG. 1, the first cord 206 can be smaller than the first plug 204. As also seen in FIG. 2, the second cord unit 208 can comprise a second cord 212 which can likewise be smaller than the second plug 210. As specifically shown in FIG. 2, the first plug 204 and the second plug 210 or the first and second cord units 202, 208 are connected together, thereby connecting the first cord unit 202 with the second cord unit 208.

As also seen in FIG. 2, the cord system 200 further comprises the cord connector 100. As seen in FIG. 2, the cord connector 100 extends from the first cord unit 202 to the second cord unit 208 to thereby secure the first and second cord units 202, 208 in their connected position. As also seen in FIG. 2, the elongate member 102 of the cord connector 100 extends to substantially parallel to the central axis of the first plug 204 and the second plug 210. As further seen in FIG. 2, the first loop 108 can be configured to receive, and has received the second cord 212 in the first receiving area 110. As also seen in FIG. 2, the first 108 can slide longitudinally along the second cord 212 away from the second plug 210, but cannot slide longitudinally along the second cord unit 208 past the second plug 210.

As further seen in FIG. 2, the second loop 116 can be configured to receive, and has received the first cord 206 in the second receiving area 118. As also seen in FIG. 2, the second receiving area 118 is smaller than the dimension of the first plug 204. Thus, the second loop 116 can slide longitudinally along the first cord 206 away from the first plug 204, but cannot slide longitudinally along the first cord unit 202 past the first plug 204.

A person of skill in the art will recognize that a cord system 200 can include more of fewer components than those specifically outlined above, and that the components of the cord system 200 can be used in the same or different fashion as outlined above.

Some embodiments relate to methods of using a cord connector 100 with the first cord unit 202 and a second cord unit 208. In such an embodiments, the first plug 204 of the first cord unit 202 can be connected to and mate with the second plug 210 of the second cord unit 208. After the first and second cord units 202, 208 are engaged, the cord connector 100 can be connected to the cord system 200. In some embodiments, for example, the cord connector 100 can be connected to the cord system 200 by passing a portion of the first and/or second cord unit 202, 208 through the first access opening 112 into the first receiving area 110 of the first loop 108. After positioning the elongate member 102 of the cord connector 100 such that the elongate member 102 extends along the first plug 204 and the second plug 210, a portion of the first and/or second cord units 202, 208 can be passed through the second access opening 120 into the second receiving area 118 of the second loop 116, which passing thereby secures the cord connector 100 to the first and second cord units 202, 208. In some embodiments, for example, the method of using the cord connector 100 with the first cord unit 202 and the second cord unit 208 can further include selecting a cord connector 100 having an elongate member 102 approximately the same length as the connected first plug 204 and the second plug 210. As discussed above, as the first loop 108 and the second loop 116 can be sized and shaped to allow movement of the cord connector 100 along the longitudinal axis of the first cord unit 202 and/or the second cord unit 208 to be constrained by the position of the first plug 204 and/or the second plug 210, the function of the cord connector 100 can be advantageously improved by selecting a cord connector 100 having a length of the elongate member 102 approximating the length of the connected first plug 204 and the second plug 210. In one specific embodiment, the cord connector 100 can be selected such that the elongate member 102 is approximately 0.01 inches, 0.1 connected first plug 204 and the second plug 210.

A person of skill in the art will recognize that the above outlined steps of the method of using a cord connector 100 with a cord system 200 can be performed in a different order and that additional and/or fewer steps can be used in performing the method.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

1. A cord connector comprising:
an elongate member having a first end and a second end;
a first loop located at the first end of the elongate member and extending in a first direction perpendicular to the elongate member; and
a second loop located at the second end of the elongate member and extending in the first direction perpendicular to the elongate member,
wherein said first and second loops are adapted to prevent uncoupling between a first cord passing through said first loop and a second cord passing through said second loop.

2. The cord connector of claim 1, wherein the first loop defines a first receiving area and a first access opening.

3. The cord connector of claim 1, wherein the first loop defines a first central axis located in the middle of the first receiving area and perpendicular to the first receiving area.

4. The cord connector of claim 3, wherein the first central axis is parallel to the elongate member.

5. (canceled)

6. The cord connector of claim 3, wherein the second loop defines a second receiving area and a second access opening.

7. The cord connector of claim 6, wherein the second loop defines a second central axis located in the middle of the second receiving area and perpendicular to the second receiving area.

8. The cord connector of claim 7, wherein the second central axis is parallel to the elongate member.

9. (canceled)

10. The cord connector of claim 7, wherein the first central axis is parallel to the second central axis.

11. A cord system comprising:
a first cord unit comprising a first plug, and a first cord;
a second cord unit comprising a second plug, and a second cord;
a first loop located at a first position and partially defining a perimeter of a first receiving area, wherein the first loop defines a first central axis extending through the center of the first loop and perpendicular to the first receiving area; and
a second loop located at a second position and partially defining a perimeter of a second receiving area, wherein the second loop defines a second central axis extending through the center of the second loop and perpendicular to the second receiving area;
wherein said first and second loops are adapted to prevent uncoupling between the first cord unit partially passing through said first loop and the second cord unit partially passing through said second loop.

12. The cord system of claim 11, further comprising an elongate member connecting the first and second loops.

13. The cord system of claim 12, wherein the first loop is located at a first end of the elongate member and the second loop is located at a second end of the elongate member.

14. The cord system of claim 11, wherein the cord connector is wire.

15-18. (canceled)

19. The cord system of claim 11, further comprising: a first access opening partially defining the perimeter of the first receiving area and configured to allow an object to be moved, perpendicular to the first central axis, into the first receiving area.

20. The cord system of claim 11, further comprising a second access opening partially defining the perimeter of the second receiving area and configured to allow an object to be moved, perpendicular to the second central axis, into the second receiving area.

21. The cord system of claim 11 wherein the first and second central axes are parallel.

22. A method of using a cord connector to maintain a connection between a first cord unit and a second cord unit, the method comprising:
connecting a first plug of a first cord unit to a second plug of a second cord unit;
placing a portion of a first cord of the first cord unit in a first receiving area of a first loop of a cord connector, wherein the first loop is smaller than the first plug; and
placing a portion of the second cord unit into a second receiving area of a second loop of the cord connector, wherein the second loop is smaller than the second plug.

23. The method of claim 21, wherein the portion of the first cord of the first cord unit is placed in the first receiving area of the first loop of the cord connector by passing the first cord through a first access opening.

24. The method of claim 21, wherein the portion of the second cord of the second cord unit is placed in the second receiving area of the second loop of the cord connector by passing the second cord through a second access opening.

25. The method of claim 21, wherein an elongate member of the cord connector is positioned adjacent to the first plug and the second plug when the first cord is positioned in the first receiving area and the second cord is positioned in the second receiving area.

26. The method of claim 21 further comprising selecting a cord connector having approximately the same length as the length of the connected first plug and second plug.

27. (canceled)
